(19) United States
(12) Patent Application Publication
(10) Pub. No.: US 2010/0060859 A1
(43) Pub. Date: Mar. 11, 2010

(54) PROJECTION DISPLAY WITH LED-BASED ILLUMINATION MODULE

(75) Inventors: Marcellinus Petrus Carolus Michael Krijn, Eindhoven (NL); Ramon Pascal Van Gorkom, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/515,422

(22) PCT Filed: Nov. 26, 2007
(86) PCT No.: PCT/IB07/54785

§ 371 Date: May 19, 2009

(30) Foreign Application Priority Data
Nov. 28, 2006 (EP) 06124868.8

(51) Int. Cl. G03B 21/28

(52) U.S. Cl. 353/31; 353/37

(57) ABSTRACT

A projection display device comprising an illumination module (100; 200; 301) and at least one projection lens (304) for projecting light from said illumination module (301) onto a projection screen (305) is provided. The illumination module (100) comprises at least two lighting units (103, 104), each comprising of a light emitting diode (113, 114) and a collimating funnel (130, 140) arranged in front thereof. The output areas (132, 142) of the two funnels are at least partly overlapping. Hence, light collimation and mixing is possible in the same structure, yielding an etendue conserving illumination module.

### FIELD OF THE INVENTION

The present invention relates to a projection display device, comprising an illumination module and at least one image projection lens for projecting light from the illumination module onto a projection screen. The present invention also related to an image light generating system for use in a projection display device.

### BACKGROUND OF THE INVENTION

Projection display devices are display devices that project an image on a projection screen. Examples of projection display devices include, for example, rear-projection television sets and computer image projectors.

Typically, a projection display device comprises a light source that illuminates one or more image forming devices. Illumination light from the light source is reflected from or transmitted through the image forming device and this reflected or transmitted illumination light is projected on a screen, typically via a system of projection lenses.

Examples of image forming devices include transmissive and reflective LCD-panels, such as the LCoS (Liquid Crystal on Silicon) panel, and digital micro-mirror panels, such as the panels commonly known as DLP™, supplied by Texas Instruments, Plano, Tex.

Currently, UHP (Ultra High Performance) lamps are conventionally used as the light source in projection display devices.

However, the recent progress in the field of light emitting diodes (LED) has led to LEDs with increased brightness, and in the coming years, the brightness from LEDs are anticipated to further increase, making LED based projection display devices an attractive alternative to UHP based projection display devices.

The ultimate brightness of the light illuminating the image forming device determines the lumen output of the display device, and the ultimate brightness of the light illuminating the image forming device is dependent on the etendue of the illumination light; for a given light source output power, if the etendue is increased, the resulting light is less bright, i.e. there is less optical power illuminating the image forming device per area unit.

Thus, it is important that the optical flux density of the light source is conserved.

The etendue ε of an optical system is calculated by the formula ε=A*Ω, where A is the area of the emitter or receiver, and Ω is the solid angle (in steradians) of the emission or reception.

The brightness (B) is defined as the amount of lumens (Φ) emitted per area (A) and per unit of solid angle (Ω):

$$B = \frac{Φ}{A ⋆ Ω} = \frac{Φ}{ɛ}$$

An LED based projection display device is disclosed in US 2006/0139580 A1, where the light source comprises a plurality of light emitting diodes which emit light into a light-collecting system which transforms the light from the LEDs into a substantially telecentric illumination beam. The beam then passes through an integrating tunnel, to form a beam having a substantially uniform brightness cross-sectional profile.

LEDs typically emit light in a large solid angle (such as Lambertian half sphere emission). Hence, in order to collect as much as possible of the light emitted by the LEDs, a light-collecting system, typically consisting of side-by-side lenses or collimating funnels, is arranged in front of each of the light emitting diodes. This however results in that the cross-sectional area of the integrating tunnel is substantially larger than the combined area of the light emitting diodes.

Thus, the etendue is much increased from the light emitting diodes to the integrating tunnel.

Further, in order for the beam exiting the integrating tunnel to have a substantially uniform brightness cross-sectional profile, the length of this tunnel has to be of a significant length, which limits the possibilities of making a compact projection display device.

### SUMMARY OF THE INVENTION

It is an object of the present invention to at least partly overcome this problem, and to provide an LED based projection display device that obviates the need for an integrating tunnel.

Another object of the present invention is to provide an LED bases projection display device having an etendue-conserving light source.

These and other objects are at least partly met by a projection display device according to the appended claims.

The present inventors have found that a light collimating and mixing structure based on an intelligent arrangement of several separate collimators that at least in part are arranged within each other, and that have selectively transmissive and reflective sidewalls, may be used both to collimate the light from the light emitting diodes, and to essentially homogenously mix the light from the separate light emitting diodes, without essentially increasing the etendue of the light source.

Hence, in a first aspect, the present invention relates to a projection display device comprising an illumination module and at least one projection lens for projecting light from said illumination module onto a projection screen.

The illumination module comprises at least two lighting units, each comprising a collimating funnel arranged in front of a corresponding light emitting diode.

Each collimating funnel comprises an input area arranged towards said corresponding light emitting diode, an output area being larger than said input area and sidewalls connecting said input area and said output area.

The sidewalls of each collimating funnel are reflective for light from the corresponding light emitting diode.

The output area of each of the collimating funnels at least partly overlaps with the output area of at least one other of said at least two collimating funnels.

A portion of the sidewalls of each of the collimating funnels, which portion is located in the light path between the input area and the output area of one other of said at least two collimating funnels, is transmissive for light from the light emitting diode corresponding to said one other collimating funnel.

The light from each one of the light emitting diodes may be collimated by a separate, corresponding collimating funnel. Due to the possibility to arrange the separate collimating funnels partly within each other, the total output area is smaller than the output area of each collimating funnels multiplied by the number of funnels. Hence, the brightness (B) of light exiting the illumination module will be high, since the total output area (A) can be kept small.

Further, due to the at least partly overlapping output areas of the separate funnels, a good light mixing will take place in the illumination module.

In the illumination module used in the present invention, light from the light emitting diodes are thus both collimated and mixed in the same structure, instead of collimating the light in one structure and then mixing the light in a following structure (or vice versa) as was the case in the prior art. This clearly simplifies the design of a projection display device of the present invention, and the need for an integrating tunnel is reduced or even obviated.

In preferred embodiments, the projection display device of the present invention further comprises an image forming device arranged in the beam path between said illumination module and said at least one projection lens to be illuminated by said illumination module. The image forming device spatially modulates light from said illumination module to form image light to be projected by said projection lens.

The image forming device may be a reflective or transmissive image forming device. An image forming device selectively reflects or transmits portions of the light which illuminates the image forming device such that the selectively reflected or transmitted portions of the light (i.e. the image light) represents an image that can be projected.

In embodiments of the present invention the illumination module may comprises at least three, such as at least four, lighting units.

In an illumination module comprising three lighting units, a white light emitting illumination module is obtainable, such as an RGB (red-green-blue). In an illumination module comprising four lighting units, an RGBA (red-green-blue-amber) can be obtained. Such illumination modules are capable of producing light of large color variability.

In embodiments of the present invention, portions of the sidewalls of the a collimating funnel, which portion is located within the collimating funnel of one other lighting unit, is provided with a dichroic filter that is transmissive for light from the light emitting diode of said other lighting unit.

The possibility of arranging filters to handle the selective transmission and reflection gives a freedom in designing the collimating structure, since the filters can be arranged on any material forming the sidewalls of the collimator, or may even constitute the material forming the sidewalls of the collimator.

To obtain the selective reflection and the selective transmission, the portions of the sidewalls are provided with, typically coated with, or consisting of, a filter material having the desired properties.

In embodiments of the present invention, said dichroic filter may comprise alternating layers of two or more materials having different refractive index.

Such filters, based on interference stacks, are very well suited as the selectively transmissive and selectively reflective filters as they easily can be adapted to selectively reflect and transmit light of different wavelengths, and have a very low absorption for the wavelengths of interest.

In embodiments of the present invention, the output area of each one of said collimating funnels essentially fully overlaps with the output area of at least one other of said collimating funnels.

When the output areas of the collimators fully overlap, all light from the light source will exit the collimating structure through the same area, irrespective of which of the light emitting diodes of the lighting unit that produces the light. Hence, the shape, direction and intensity cross-section of the light will be essentially the same for all the light emitting diodes of the lighting unit. This gives a very good color mixing.

In embodiments of the present invention light integrating optics may be arranged in the beam path between said illumination module and said at least one projection lens. When applicable, the light integrating optics is arranged beam path between said illumination module and the image forming device.

Integrating optics may be used, if necessary, to further integrate the light from the illumination module, such that the intensity and color distribution is essentially homogenous over the cross-section of the light beam from the illumination module.

For example, the light integrating optics may comprise a fly-eye integrator.

A fly-eye integrator may be used to project light from any specific portion of the cross section of the light beam from the illumination module onto essentially the whole projection lens, or image forming device when such is present, leading to a very homogenous illumination of the projection lens or the image forming device.

In embodiments of the present invention, the light integrating optics may comprise an integrating tunnel arranged on the illumination module.

An integrating tunnel arranged directly on the illumination module will yield a very homogenous intensity and color distribution from a very compact structure.

In a second aspect, the present invention also relates to an image light generating system for a projection display device, comprising an illumination module as defined in the present specification and an image forming device arranged to be illuminated by said illumination module and to spatially modulate light from said illumination module to form image light.

### BRIEF DESCRIPTION OF THE DRAWINGS

This and other aspects of the present invention will now be described in more detail, with reference to the appended drawings showing a currently preferred embodiment of the invention.

FIG. 1a illustrates an embodiment of an illumination module used in a projection display device of the present invention.

FIG. 1b illustrates another embodiment of an illumination module used in a projection display device of the present invention.

FIG. 2 illustrates yet another embodiment of an illumination module used in a projection display device of the present invention.

FIG. 3 illustrates an embodiment of a projection display device according to the present invention.

FIG. 4 illustrates another embodiment of a projection display device according to the present invention.

FIG. 5 illustrates yet another embodiment of a projection display device according to the present invention.

### DETAILED DESCRIPTION

The present invention relates in one aspect to a projection display device, comprising an illumination module and at least one projection lens for projecting light from the illumination module onto a projection screen. Typically, the projection display device also comprises an image forming device arranged in the beam path between the illumination module and the at least one projection lens.

In another aspect, the present invention relates to an image forming system for a projection display device. Such an image forming system comprises an illumination module and an image forming device which is arranged to be illuminated by light from the illumination module, and to spatially modulate the illumination light into image light, which then can be projected onto a projection screen.

Hence, any description herein regarding the illumination system and the image forming device applies to both the projection display device and the image light generating system.

In a typical projection display device, illumination light from one or more light sources is incident on (i.e. illuminates) one or more image forming devices. Thereafter, light from the image forming device is projected on a projection screen. The image forming device may be a transmissive device, where the light transmitted through the image forming device is projected on a projection screen, or alternatively, the image forming device may be a reflective image forming device, where light reflected on the device is projected on a projection screen.

The light from the image forming device it typically projected (focused and directed) by means of projection optics, such as lens systems, arranged between the image forming device and the projection screen.

Optical elements, such as relay lens systems, light integrators, etc, may be arranged in the beam path between the illumination module and the image forming device in order to suitably illuminate the image forming device.

Image forming devices of reflective type include, but are not limited to the LCD-type, such as LCoS (liquid crystal on silicon), or the digital micro-mirror device (DMD) type, such as DLP™, as well as of any other type known to those skilled in the art, where light selectively reflected by the device constitute the image light.

Image forming devices of transmissive type include, but are not limited to a transmissive liquid crystal cell, where the light selectively transmitted through the device constitutes the image light.

While the following description addresses both LCD- and DMD-type of image forming devices, there is no intention to restrict the scope of the invention to only these two types of image forming devices, and the illumination module described herein may be used with other types of devices for forming an image that is projected by a projection system.

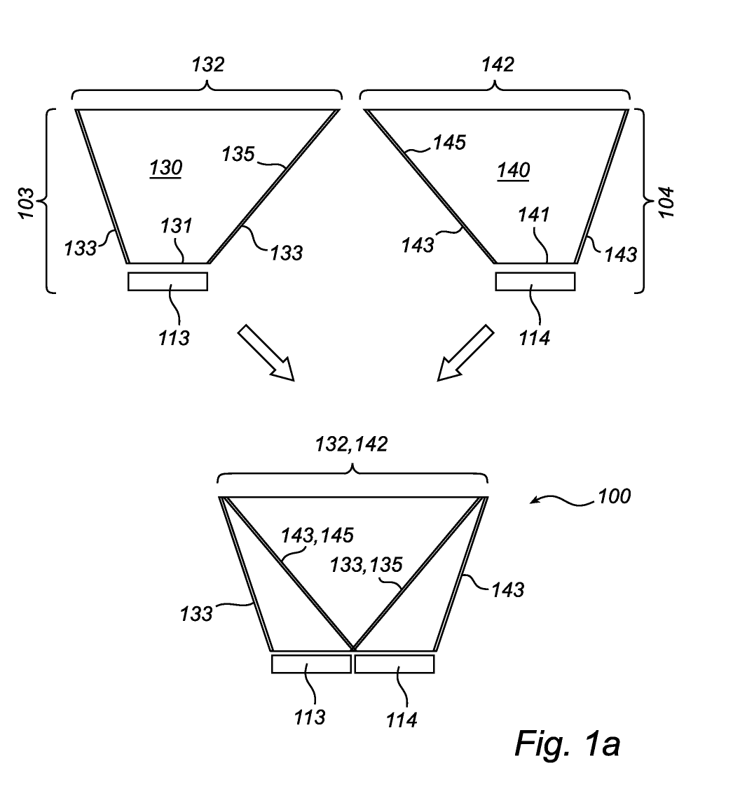

The illumination module will now be described in detail with reference to FIG. 1a showing a simplified embodiment comprising two lighting units, each comprising a light emitting diode and a collimating funnel.

As will be realized by those skilled in the art, and as will be described below in preferred embodiments of the illumination module, the illumination module may very well be adapted to more than two light emitting diodes and more than two collimators, such as three, four or five light emitting diodes and collimators.

The illumination module 100 suitable for use in a projection display device or an image generating system of the present invention comprises a first lighting unit 103 and a second lighting unit 104.

Each of the lighting units 103, 104 comprises a collimating funnel 130, 140 arranged in front of a corresponding light emitting diode 113, 114.

As used herein, the terms “in front of” and “in rear of” are relative terms to describe the position of one object in relation to another object, counted in the main direction of light through the display device of the present invention, where the main direction of light is from the light sources to the projection screen, which the light from the light sources eventually illuminates.

The light sources are constituted by a plurality of light emitting diodes 113, 114 emitting light of different wavelength spectra, i.e. emitting light of different color or color temperatures.

The first light emitting diode 113 emits light of a first wavelength spectrum (e.g. a first color) and a second light emitting diode 114 emits light of a second wavelength spectrum (e.g. a second color)

The light emitting diodes 113, 114 are typically arranged side-by-side on a substrate (not shown) and emit light in essentially the same general direction, with a mean direction along the normal to the substrate.

The plurality of light emitting diodes are typically independently addressable, such that the intensity of light from the first light emitting diode 113 can be controlled independently from the intensity from the second light emitting diode 114 in the illumination module 100.

As used herein, “light emitting diodes” relates to all different types of light emitting diodes (LEDs), including organic based LEDs, polymeric based LEDs and inorganic based LEDs, which in operating mode emit light of any wavelength or wavelength interval, from ultra violet to infrared. Light emitting diodes, in the context of this application, are also taken to encompass laser diodes, i.e. light emitting diodes emitting laser light.

In front of each of the light emitting diodes 113, 114 is arranged a light collimating funnel 130, 140, which is adapted to receive at least part of the light emitted by its corresponding light emitting diode 113, 114 and to collimate the received light.

As used herein, the terms “collimator” and “collimating funnel” refer to optical elements capable of receiving electromagnetic (EM) radiation, e.g. light in the interval from UV to IR, and reducing the angular spread angle of the received EM-radiation.

Each of the collimating funnels 130, 140 has a receiving area 131, 141, and output area 132, 142, and sidewalls 133, 143 connecting the receiving area with the respective output area. The output area 132, 142 is larger than the respective receiving area 131, 141.

The sidewalls 133, 143 are generally tapering outwards from the receiving area 131, 141 to the output area 132, 142. Hence each of the collimators 130, 140 are funnel shaped.

A first collimating funnel 130 is arranged in front of the first light emitting diode 113 to form a first lighting unit. The sidewalls 133 of the first collimating funnel 130 are reflective for light from the first light emitting diode 113. Hence, light from the first light emitting diode will be collimated in the first collimating funnel.

A second collimating funnel 140 is arranged in front of the second light emitting diode 114. The sidewalls 143 of the second collimating funnel are reflective for light from the second light emitting diode 114. Hence, light from the second light emitting diode will be collimated in the second collimating funnel.

The output area 132 of the first collimating funnel 130 overlaps with the output area 142 of the second collimating funnel 140.

Hence, a portion 135 of the sidewalls 133 of the first collimating funnel 130 is located within the second collimator 140, i.e. in the light path between the receiving area 141 and the output area 142 of the second collimating funnel 140, and consequently, a portion 145 of the sidewalls 143 of the second collimating funnel 140 is located within the first collimating funnel 130.

The portion 135 of the sidewalls 133 of the first collimating funnel 130 that is located within the second collimating funnel 140, especially in the beam path between the receiving area 141 and the output area 142, is arranged such that it is transmissive to light from the second light emitting diode 114, i.e. transmissive to light of the second wavelength spectrum, while being reflective for light from the first light emitting diode 113, i.e. reflective to light of the first wavelength spectrum.

In an analogue manner, the portion 145 of the sidewalls 143 of the second collimating funnel 140 that is located within the first collimator 130, especially in the beam path between the receiving area 131 and the output area 132, is arranged such that it is transmissive to light from the first light emitting diode 113, i.e. transmissive to light of the first wavelength spectrum, while being reflective for light from the second light emitting diode 114, i.e. reflective to light of the second wavelength spectrum.

As a result, the light from the first light emitting diode 113 will be collimated essentially independently from the light of the second light emitting diode 114, even though the first collimating funnel 130 is partly located within the second collimating funnel 140 and vice versa.

The selectively transmissive and reflective properties of the portions 135 and 145 may be achieved by providing those portions of the sidewalls with filters that reflect light of one color while transmitting light of another color.

Filters that are transmissive for light of one wavelength spectrum and reflective for another wavelength spectrum are known to those skilled in the art, for example under the collective term dichroic filters. As used herein, the term “dichroic filter” relates to a filter that reflects electromagnetic radiation of one or more wavelengths or wavelength ranges, and transmits radiation of other wavelengths or wavelength ranges

A dichroic filter may be of high-pass, low-pass, band-pass or band rejection type.

Preferred examples of the dichroic filters for use in the present invention include so-called interference stacks. An interference stack is a multi-layer stack containing alternating layers of material having different refractive index and/or thickness.

One example of an interference stack comprises alternating layers of Ta₂O₅ and SiO₂, where the thickness of each layer is typically approximately equal to a quarter of the wavelength in air divided by the index of refraction, where the wavelength in air equals the dominant wavelength of the light that the dichroic filter reflects.

Other examples of dichroic filters known to those skilled in the art and suitable for use in the present invention are such filters based on cholesteric liquid crystals, so called photonic crystals, or holographic layers.

Further, the dichroic filters may be non-ideal, i.e. not reflecting 100% of the light in the wavelength range in which the filter is to reflect light and/or not transmitting 100% of the light the wavelength range in which the filter is to transmit light.

Thus, the term “filter reflective for light of a first wavelength spectrum and transmissive for light of a second wavelength spectrum” is to be taken as “filter that at least partially reflect light of a first wavelength spectrum and that at least partially transmits light of a second wavelength spectrum”.

Further, such a filter may be designed to reflect light of two wavelength spectra, while transmitting a third wavelength spectra, for example, reflecting red and green light while transmitting blue light.

Typically, the filter is arranged as a coating on the sidewalls, but may also it self constitute the sidewall.

The sidewalls of the collimators, that are reflective for light of at least one wavelength interval, may be constituted by self supporting wall elements, interfaces between two solid bodies or the interface between a solid body and the surrounding atmosphere.

In preferred embodiments of lighting modules for use in the present invention, the light source is capable of producing light of many different colors. Thus, it is preferred that the light source comprises three or more light emitting diodes emitting light of three or more colors. Examples of such lighting units include three-color lighting units, e.g. capable of emitting red, green and blue light and any combination thereof, four-color lighting units, e.g. capable of emitting red, green, blue and amber light and any combination thereof, and five-color lighting units e.g. capable of emitting red, yellow, green, cyan and blue light and any combination thereof.

The above embodiment of the illumination module can be modified to include three or more lighting units, as is illustrated in FIG. 1b, where also a third lighting unit 105, comprising a third light emitting diode 115 and a third collimating funnel 150, is included. As with the two collimating funnels 130 and 140 described above, the sidewalls 153 of the third collimating funnel is arranged such that portions 155 that are located within another one of the collimating funnels are transmissive for light from the light emitting diode corresponding to that other collimating funnel.

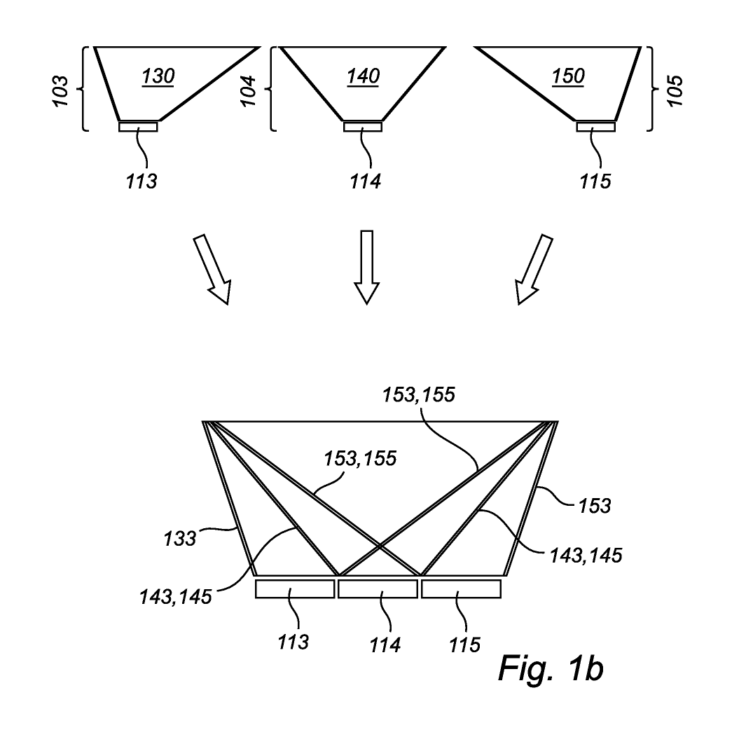

A preferred embodiment of an illumination module 200 for use in the present invention is illustrated in FIG. 2.

The illumination module 200 comprises four independently addressable light emitting diodes 211, 212, 213 and 214, each emitting light of a distinct wavelength spectrum (i.e. color) arranged side by side in a 2×2 LED matrix, for example forming a RGBA (red, green, blue, amber) LED-chip, and a collimating structure arranged in front of the light sources.

The collimating structure 220 comprises a first V-shaped profile surface 230 and a second V-shaped profile surface 240 that intersects with the first V-shaped profile surface 230 to form four separate lines of intersection 251, 252, 253 and 254.

Each of the V-shaped profile surfaces 230, 240 comprises a first leg 231, 241 and a second leg 232, 242, and an edge 235, 245 connecting the first leg 231, 241 to the second leg 232, 242.

The edges 235, 245 of the V-shaped profile surfaces 230, 240 are arranged towards the light receiving side 221 of the light-collimating element 220, i.e. towards the light emitting diodes.

The first leg 231 of the first profile surface 230 is arranged in front of the first light emitting diode 211 and the second light emitting diode 212. The second leg 232 of the first profile surface 230 is arranged in front of the third light emitting diode 213 and the fourth light emitting diode 214.

The first leg 241 of the second profile surface 240 is arranged in front of the first light emitting diode 211 and the third light emitting diode 213. The second leg 242 of the second profile surface 240 is arranged in front of the second light emitting diode 212 and the fourth light emitting diode 214.

Further, the first light emitting diode 211 is arranged in rear of the line of intersection 251 between the first leg 231 of the first profile surface 230 and the first leg 241 of the second profile surface 240. The second light emitting diode 212 is arranged in rear of the line of intersection 252 between the first leg 231 of the first profile surface 230 and the second leg 242 of the second profile surface 240. The third light emitting diode 213 is arranged in rear of the line of intersection 253 between the second leg 232 of the first profile surface 230 and the first leg 241 of the second profile surface 240. The fourth light emitting diode 214 is arranged in rear of the line of intersection 254 between the second leg 232 of the first profile surface 230 and the second leg 242 of the second profile surface 240.

The first leg 231 of the first V-shaped profile surface 230 is transmissive for light emitted by the first and second light emitting diodes 211, 212, but is reflective for light emitted by the diodes opposite to the first and second light emitting diodes, i.e. the third and the fourth light emitting diodes 213, 214.

The second leg 232 of the first V-shaped profile surface 230 is transmissive for light emitted by the third and the fourth light emitting diodes 213, 214, but is reflective for light emitted by the diodes opposite to the third and fourth light emitting diodes, i.e. the first and second light emitting diodes 211, 212.

The first leg 241 of the second V-shaped profile surface 240 is provided with a third dichroic filter that is transmissive for light emitted by the first and the third light emitting diodes 211, 213, but is reflective for light emitted by the second and forth light emitting diodes 212, 214.

The second leg 242 of the second V-shaped profile surface 240 is provided with a fourth dichroic filter that is transmissive for light emitted by the second and fourth light emitting diodes 212, 214, but is reflective for light emitted by the first and third light emitting diodes 211, 213.

A leg of a V-shaped profile surface does not have to have the same properties regarding the transmission and reflection over its whole extension. For example, it is possible that the filter has some different properties, with regards to transmission and reflection, in different domains of the leg.

Light from the first light emitting diode 211 will pass through the first leg 231 of the first V-shaped profile surface 230, and also pass through the first leg 241 of the second V-shaped profile surface 240, but will be reflected on the second leg 232 of the first V-shaped profile element and on the second leg 242 on of the second V-shaped profile element 130. As the second leg 232 of the first V-shaped profile element and the second leg 242 on of the second V-shaped profile element 130 are slanted away from the first light emitting diode 211, the light thereof will be reflected thereon towards the output side 222 of the collimating structure 220, and thus the light from this light emitting diode will be collimated.

A jacket 260 is arranged surrounding the vertical sides of the collimating structure. Thus, essentially all light that exits the structure will do so through the output side 222. In order to further increase the light utilization efficiency of the device, the inner surfaces of the jacket 260 may be reflective, such that light encountering such a sidewall will be reflected back into the collimating structure 220 and eventually exit the structure through the output side 222. Such reflective inner surfaces are preferably full spectrum reflecting for highest efficiency.

A first collimating funnel for collimating the light from the first light emitting diode 211 is thus formed by the second leg 232 of the first V-shaped profile surface, the second wall 242 of the second V-shaped profile surface and the inner walls of the jacket 260, which first funnel together with said first light emitting diode 211 forms a first lighting unit.

A second collimating funnel for collimating the light from the second light emitting diode 212 is formed by the second leg 232 of the first V-shaped profile surface, the first leg 242 of the second V-shaped profile surface and the inner walls of the jacket 260, which second funnel together with said second light emitting diode 212 forms a second lighting unit.

A third collimating funnel for collimating the light from the third light emitting diode 213 is formed by the first leg 231 of the first V-shaped profile surface, the second leg 242 of the second V-shaped profile surface and the inner walls of the jacket 260, which third funnel together with said third light emitting diode 213 forms a third lighting unit.

A fourth collimating funnel for collimating the light from the fourth light emitting diode 214 is formed by the first leg 231 of the first V-shaped profile surface, the first leg 241 of the second V-shaped profile surface and the inner walls of the jacket 260, which fourth funnel together with said fourth light emitting diode 214 forms a fourth lighting unit.

Thus, light from all four light emitting diodes will be collimated essentially independently from each other and will exit the light collimating structure 220 through the output side 222 thereof. Since the light from all four light emitting diodes exit the collimating structure through the same area, a good color mixing is provided. Thus, collimation and mixing is performed in the same structure.

In the following, a projection display device of the present invention will be described. As recognized by those skilled in the art, any illumination module as defined in this invention, and not limited to those described above, may be used in any of the following projection display devices described below.

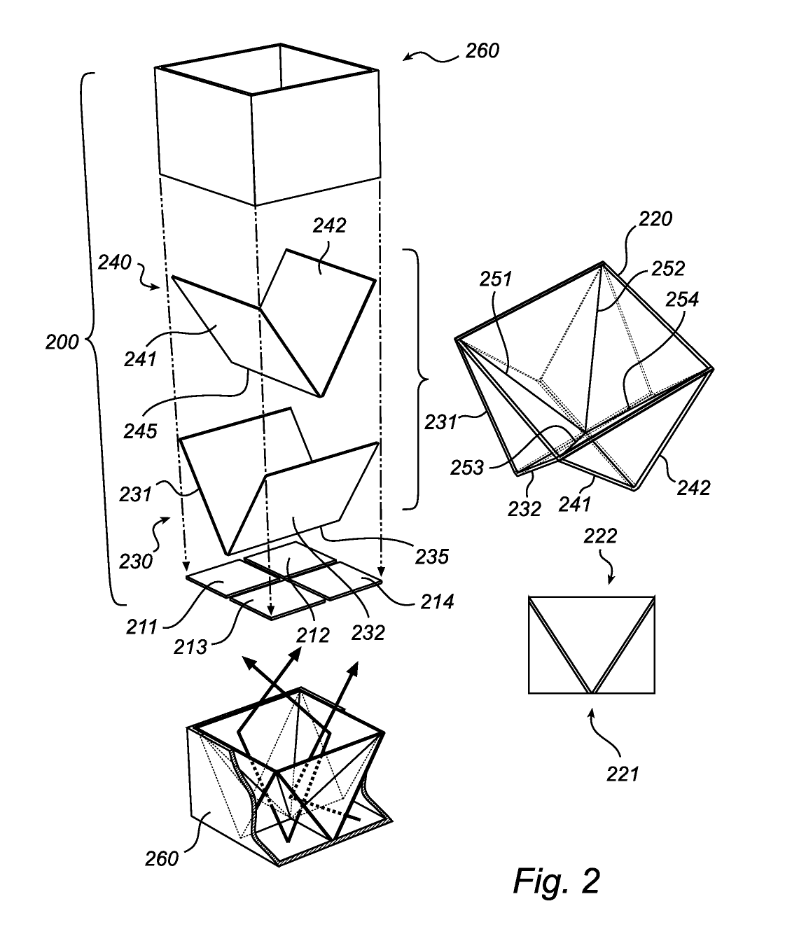

One embodiment of a projection display device 300 is illustrated in FIG. 3 and comprises an illumination module 301 as defined in the present specification and a transmissive LC (liquid crystal) based image forming device 302, which together forms an image light generating system.

The illumination module illuminates the image forming device 302 which selectively lets light be transmitted through it.

The projection display device 300 also comprises one or more control units 303 to control the light emission from the illumination module 301 and to control the transmission of light through the image forming device 302.

The display device 300 also comprises a projection lens system 304 for focusing the light transmitted through the image forming device 302 onto a projection screen 305.

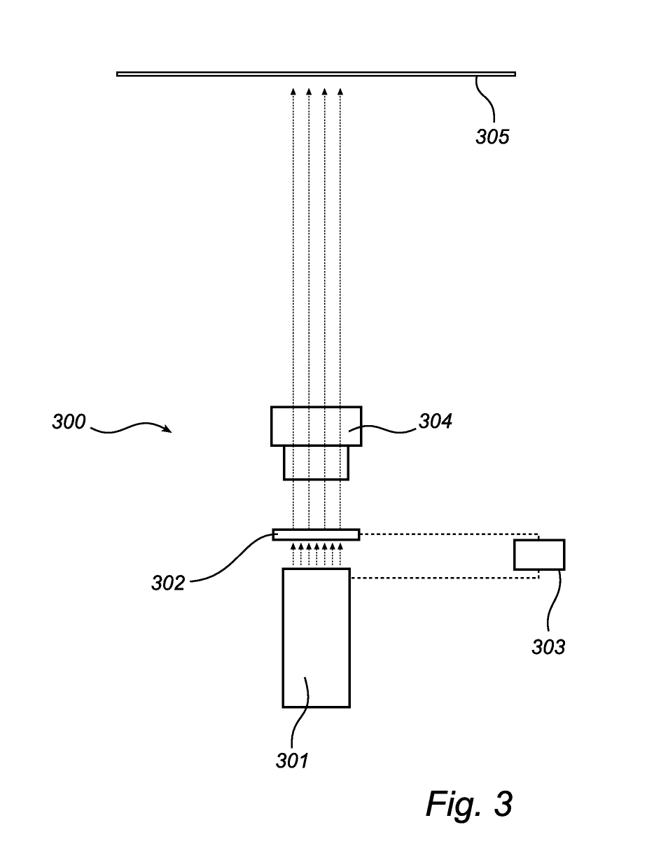

Another embodiment of a projection display device 400 is illustrated in FIG. 4 and comprises an image light generating system comprising an illumination module 401 as defined in the present specification and a reflective LCoS (Liquid Crystal on Silicon) based image forming device 402.

The display device 400 also comprises one or more control units 403 to control the light emission from the illumination module 401 and to control the on-and-off state of the pixels of the LCoS device 402.

The light from the illumination module 401 illuminates the LCoS device 402, via a series of relay optics 404 and a polarized beam splitter 405. The light from the beam splitter is linearly polarized, and for pixels of the LCoS device in the on state, light will be reflected into the beam splitter 405 having a reversed polarization. The reflected light passes through the beam splitter 405 towards a projection screen 406 via a projection lens system 407.

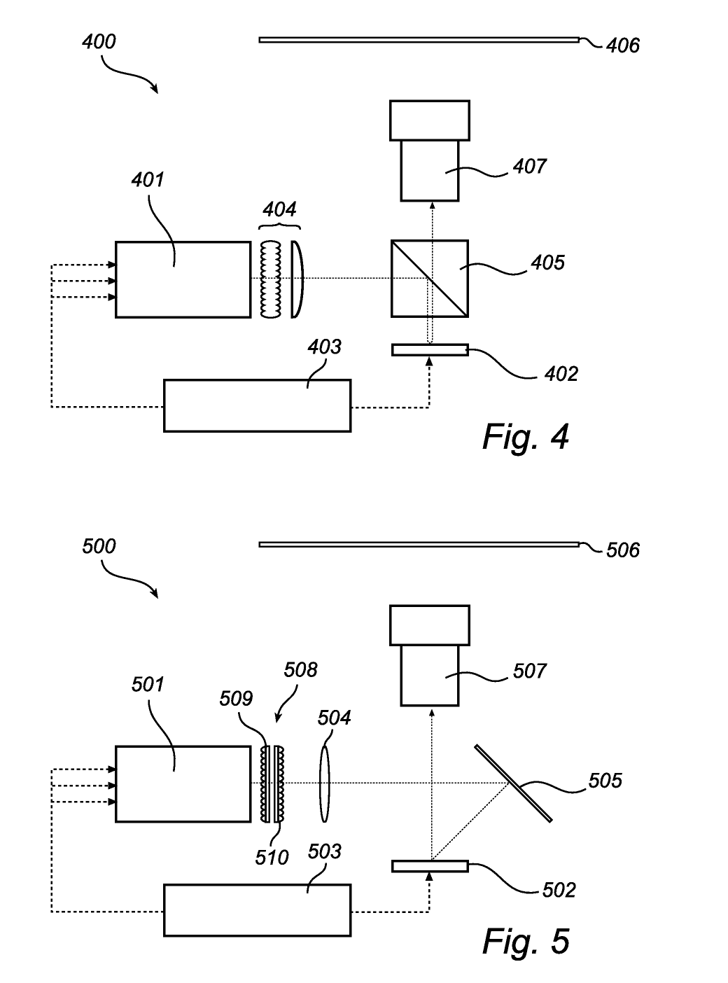

Yet another embodiment of a projection display device 500 is illustrated in FIG. 5 and comprises an image light generating system comprising an illumination module 501 as defined in the present specification and a reflective digital micro-mirror (DMD) based image forming device 502.

The display device 500 also comprises one or more control units 503 to control the light emission from the illumination module 501 and to control the on-and-off state of the pixels of the DMD device 502.

The light from the illumination module 501 illuminates the DMD-device 502 via a series of relay optics 504 and mirrors 505.

For the pixels of the DMD-device in the on state, light will be reflected towards a projection screen 506 via a projection lens system 507.

Further, as is illustrated in this embodiment, but which is applicable to all of the embodiments of projection displays according to the present invention, light integration optics 508 may be arranged in the light path between the illumination module 501 and the image-forming device 502. The function of the light integration optics 508 is to further, if needed, homogenize the light from the illumination module, such that essentially the whole image-forming device can be illuminated with light of the same intensity and color content. In a preferred embodiment, the light integration optics 508 comprises a fly's-eye integrator. A fly's-eye integrator typically comprises at least a first array of lenses 509 arranged on a plane with its normal aligned along the direction of light through the plane, and typically also a second such array 510 arranged in front of the first array 509. The distance between the two lens arrays 509, 510 corresponds essentially to the focal length of the lenses of the arrays. In front of the lens arrays 509, 510, a converging lens or lens system 511 is arranged, having a focal length F corresponding to the distance to the image-forming device. With this configuration, each lens of the first lens array 509 picks out a certain portion of the light exiting the illumination module and images this portion onto the complete micro-display panel.

For this to work, the angular spread of the light leaving the illumination module and entering the fly's-eye integrator should be small enough, typically less than about 30°. An angular spread below 30° can easily be obtained by an illumination module as used in the present invention. Hence there is no absolute need for any additional collimation optics to be located in the light path between the illumination module and the integrator.

Alternatively, integration optics comprising an integration tunnel, i.e. a transmissive tunnel (hollow or made of a transmissive material) with reflecting sidewalls, may be arranged in front of, such as arranged on, the illumination module to further homogenize the light from the illumination module.

Such an integrating tunnel may have a cylindrical shape, with parallel sidewalls of the tunnel or may have funnel-like shape, such that the cross-section of the tunnel increases with the distance from the illumination module. By using a funnel-shaped tunnel, one can further tune the degree of collimation of the light to better match the size of the image-forming device and/or to better match the acceptance angle of the projection lens.

The person skilled in the art realizes that the present invention by no means is limited to the preferred embodiments described above. On the contrary, many modifications and variations are possible within the scope of the appended claims. For example, in the figures to the embodiments described above, the sidewalls of the collimators are illustrated as being straight, in the sense that the angle between the surface of the sidewalls and the normal to the substrate is constant, independently on the distance from the substrate.

However, the present invention is not limited to this. In fact, it may be advantageous in some cases that the angle between the surface of the sidewalls and the normal to the substrate is varying, and especially decreasing, with the distance from the substrate. For example, the sidewalls of the collimators may be curved such that the cross-section of the collimator resembles that of a parabola. One such example is the collimator shape commonly known as compound parabolic collimator. For such a collimator shape, the height of the collimator may be reduced, compared to a straight wall collimator, in order to obtain the same degree of collimation. Hence, it is contemplated the term “V-shaped profile surfaces” as is used above in conjunction with one of the embodiments described above, also should encompass “U-shaped profile surfaces”

Further, the embodiments of the projection display device illustrated and described above are only examples of projection display devices in which an illumination module as used in the present invention may be used. Those skilled in the art will recognize that the scope of the present invention includes all projection display devices in which an illumination module as defined in the present invention is used to illuminate an image-forming device.

1. A projection display device (300) comprising an illumination module (100; 200; 301) and at least one projection lens (304) for projecting light from said illumination module (301) onto a projection screen (305), said illumination module comprising:
at least two lighting units (103, 104), each comprising a collimating funnel (130, 140) arranged in front of a corresponding light emitting diode (113, 114),
each collimating funnel (130, 140) comprising an input area (131, 141) arranged towards said corresponding light emitting diode (113, 114), an output area (132, 142) being larger than said input area (131, 141) and sidewalls (133, 143) connecting said input area (131, 141) and said output area (132, 142), wherein
the sidewalls (133, 143) of each collimating funnel (130, 140) are reflective for light from the corresponding light emitting diode (113, 114),
the output area (132) of each of the collimating funnels (130) at least partly overlaps with the output area (142) of at least one other of said at least two collimating funnels (140)
a portion (135, 145) of the sidewalls of each of the collimating funnels (130, 140), which portion is located in the light path between the input area (141, 131) and the output area (142, 132) of one other of said at least two collimating funnels (140, 130), is transmissive for light from the light emitting diode (114, 113) corresponding to said one other collimating funnel (140, 130).

2. A projection display device according to claim 1, further comprising an image forming device (302) arranged in the beam path between said illumination module (301) and said at least one projection lens (304) to be illuminated by said illumination module (301), wherein said image forming device (302) spatially modulates light from said illumination module (301) to form image light to be projected by said projection lens (304).

3. A projection display device according to claim 1, wherein said illumination module (100, 200) comprises at least three, such as at least four lighting units.

4. A projection display device according to claim 1, wherein said portion (135, 145) of the sidewalls of a collimating funnel (130, 140) is provided with a dichroic filter that is transmissive for light from the light emitting diode (114, 113) of said other lighting unit (140, 130).

5. A projection display device according to claim 4, wherein said dichroic filter comprises alternating layers of two or more materials having different refractive index.

6. A projection display device according to claim 1, wherein the output area (132, 142) of each one of said collimating funnels (130, 140) fully overlaps with the output area (142, 132) of at least one other of said collimating funnels (140, 130).

7. A projection display device (500) according to claim 1, wherein light-integrating optics (508) is arranged in the beam path between said illumination module (501) and said at least one projection lens (504).

8. A projection display device according to claim 7, wherein said light integrating optics (508) comprises a fly-eye integrator (509, 510).

9. A projection display device according to claim 7, wherein said light integrating optics comprises an integrating tunnel arranged on the illumination module.

10. A projection display according to claim 1, wherein said illumination module (200) comprises four light sources (211, 212, 213, 214) in quadrangular arrangement, and a collimating structure (220) arranged in front of said light sources, said collimating structure having a receiving side (221) for receiving light from said light sources and an opposite output side (222), wherein
said collimating structure (220) comprises two intersecting V-shaped profile surfaces (230, 240), the edges of said V-shaped profile surfaces (235, 245) being arranged towards said receiving face (221),
said collimating structure (220) is arranged in front of said light sources (211, 212, 213, 214), such that each of said light sources is located in rear of a separate line of intersection (251, 252, 253, 254) between said two V-shaped profile surfaces (230, 240),
each leg (231, 232, 241, 242) of said V-shaped surfaces is provided with a dichroic filter that is transmissive for light from the pair of adjacent light sources arranged in rear of said leg, and that is reflective for light from the opposite pair of adjacent light sources.

11. An image light generating system for a projection display device, comprising an illumination module (100, 200, 301) and an image forming device (302) arranged to be illuminated by said illumination module and to spatially modulate light from said illumination module (301) to form image light, wherein illumination module comprises:
at least two lighting units (103, 104), each comprising a collimating funnel (130, 140) arranged in front of a corresponding light emitting diode (113, 114),
each collimating funnel (130, 140) comprising an input area (131, 141) arranged towards said corresponding light emitting diode (113, 114), an output area (132, 142) being larger than said input area (131, 141) and sidewalls (133, 143) connecting said input area (131, 141) and said output area (132, 142), wherein
the sidewalls (133, 143) of each collimating funnel (130, 140) are reflective for light from the corresponding light emitting diode (113, 114),
the output area (132) of each of the collimating funnels (130) at least partly overlaps with the output area (142) of at least one other of said at least two collimating funnels (140)
portion (135) of the sidewalls of each of the collimating funnels (130), which portion is located in the light path between the input area (141) and the output area (142) of one other of said at least two collimating funnels (140), is transmissive for light from the light emitting diode (114) corresponding to said one other collimating funnel (140).
